(19) United States
(12) Patent Application Publication
(10) Pub. No.: US 2026/0018637 A1
(43) Pub. Date: Jan. 15, 2026

(54) GAS FLOW RATE MEASUREMENT FOR REDOX FLOW BATTERY SYSTEMS AND OTHER CLOSED SYSTEMS AND METHODS OF MAKING AND USING

(71) Applicant: Cougar Creek Technologies, LLC, KIRKLAND, WA (US)

(72) Inventor: Liyu Li, Bellevue, WA (US)

(21) Appl. No.: 18/773,260

(22) Filed: Jul. 15, 2024

(51) Int. Cl. H01M 8/04746; G01F 1/37; G01F 23/00; H01M 8/0438; H01M 8/18

(52) U.S. Cl. CPC H01M 8/04753; G01F 1/372; G01F 23/0007; H01M 8/04432; H01M 8/186

(57) ABSTRACT

A U-tube arrangement for monitoring, observing, or measuring gas flow or gas generation of in a closed system can include a U-tube having a first arm, a second arm, and a bridge connecting the first arm to the second arm; a liquid disposed in the U-tube; an attachment conduit for coupling to the closed system and in fluid communication with the first arm of the U-tube and the closed system; a first valve for controlling fluid flow between the first arm of the U-tube and the closed system; an external conduit in fluid communication with the second arm of the U-tube and either an external atmosphere or external pressure source; and liquid level sensors disposed along at least one of the first arm or the second arm.

### FIELD

The present invention is directed to the area of redox flow battery systems and methods of making and using redox flow battery systems. The present invention is also directed systems and methods for gas flow rate measurement, observation, or monitoring for redox flow battery systems or other closed systems and methods of making and using.

### BACKGROUND

The cost of renewable power generation has reduced rapidly in the past decade and continues to decrease as more renewable power generation elements, such as solar panels, are deployed. However, renewable power sources, such as solar, hydroelectric, and wind sources, are often intermittent and the pattern of user load does not typically coincide with the intermittent nature of the sources. There is a need for an affordable and reliable energy storage system to store power generated by renewable power sources when available and to provide power to users when there is insufficient power generation from the renewable power sources.

### BRIEF SUMMARY

One embodiment is an apparatus for monitoring, observing, or measuring gas generation in a closed system. The apparatus includes a U-tube arrangement including a U-tube having a first arm, a second arm, and a bridge connecting the first arm to the second arm, a liquid disposed in the U-tube, an attachment conduit configured for coupling to the closed system and in fluid communication with the first arm of the U-tube and the closed system, a first valve for controlling fluid flow between the first arm of the U-tube and the closed system, an external conduit in fluid communication with the second arm of the U-tube and either an external atmosphere or external pressure source, and a plurality of liquid level sensors disposed along at least one of the first arm or the second arm; a memory having instructions stored thereon; and a processor configured to execute the instructions to perform actions. The actions include opening the first valve to provide fluid communication between the closed system and the U-tube; determining a change in level of the liquid along at least one of the first arm or the second arm of the U-tube using two of the liquid level sensors; and monitoring, observing, or determining a gas flow rate based on the change in the level of the liquid between the two of the liquid level sensors and a time to produce the change in the level of the liquid between the two liquid level sensors.

A further embodiment is a redox flow battery system that includes an anolyte; a catholyte; a first electrode; a second electrode; a first half-cell in which the first electrode is in contact with the anolyte; a second half-cell in which the second electrode is in contact with the catholyte; an anolyte tank in fluid communication with the first half-cell; a catholyte tank in fluid communication with the second half-cell; and a U-tube arrangement coupled to either the anolyte tank or the catholyte tank to monitor, observe, or measure gas in a headspace of the anolyte tank or the catholyte tank. The U-tube arrangement includes a U-tube having a first arm, a second arm, and a bridge connecting the first arm to the second arm; a liquid disposed in the U-tube; an attachment conduit configured for coupling to the anolyte tank or the catholyte tank and in fluid communication with the first arm of the U-tube and either the anolyte tank or the catholyte tank; a first valve for controlling fluid flow between the first arm of the U-tube and either the anolyte tank or the catholyte tank; an external conduit in fluid communication with the second arm of the U-tube and either an external atmosphere or external pressure source; and a plurality of liquid level sensors disposed along at least one of the first arm or the second arm.

Yet another embodiment is a U-tube arrangement that includes a U-tube having a first arm, a second arm, and a bridge connecting the first arm to the second arm; a liquid disposed in the U-tube; an attachment conduit configured for coupling to the anolyte tank or the catholyte tank and in fluid communication with the first arm of the U-tube and either the anolyte tank or the catholyte tank; a first valve for controlling fluid flow between the first arm of the U-tube and either the anolyte tank or the catholyte tank; an external conduit in fluid communication with the second arm of the U-tube and either an external atmosphere or external pressure source; and a plurality of liquid level sensors disposed along at least one of the first arm or the second arm.

In at least some embodiments of the apparatus, redox flow battery system, or U-tube arrangement, the U-tube arrangement further includes a second valve for controlling fluid flow between the first arm of the U-tube and the external atmosphere. In at least some embodiments of the apparatus, redox flow battery system, or U-tube arrangement, the U-tube arrangement further includes a third valve for controlling fluid flow from the second arm of the U-tube and the external atmosphere or external pressure source. In at least some embodiments of the apparatus, redox flow battery system, or U-tube arrangement, the plurality of liquid level sensors includes at least three liquid level sensors disposed along the first arm or the second arm.

In at least some embodiments, the redox flow battery system further includes a memory having instructions stored thereon; and a processor coupled to the memory, the first valve, and the liquid level sensors and configured to execute the instructions to perform actions. The actions include opening the first valve to provide fluid communication between either the anolyte tank or catholyte tank and the U-tube; and determining a change in level of the liquid along at least one of the first arm or the second arm of the U-tube using two of the liquid level sensors.

Another embodiment is a method of measuring, observing, or monitoring gas generation in any of the apparatuses described above, the method including opening the first valve to provide fluid communication between closed system and the U-tube; and determining a change in level of the liquid along at least one of the first arm or the second arm of the U-tube using the two of the liquid level sensors

Yet another embodiment is a method of measuring, observing, or monitoring gas generation in any of the redox flow battery systems described above. The method includes opening the first valve to provide fluid communication between either the anolyte tank or catholyte tank and the U-tube; and determining a change in level of the liquid along at least one of the first arm or the second arm of the U-tube using two of the liquid level sensors.

A further embodiment is a computer readable medium having instructions stored thereon that, when executed by a processor, perform actions. The actions include opening the first valve to provide fluid communication between either the anolyte tank or catholyte tank and the U-tube; and determining a change in level of the liquid along at least one of the first arm or the second arm of the U-tube using two of the liquid level sensors.

In at least some embodiments of the apparatus, the redox flow battery system, the methods, or the computer readable medium, the liquid level sensors include a first sensor and a second sensor disposed along a one of the first arm or the second arm, wherein determining the change in the level includes, for each of the first sensor and the second sensor, determining a time that the liquid rises or lowers to that sensor.

In at least some embodiments of the apparatus, the redox flow battery system, the methods, or the computer readable medium, the method or actions further include determining or estimating a gas flow rate, Q_{gas} using the following equation:

$${Q}_{gas} = ( A * Δ h ) * ( 1 + \frac{2 * Δ h * ρ * g}{{P}_{ext}} ) / ( {t}_{2} - {t}_{1} )$$

wherein A corresponds to a cross-sectional area of the one of the first arm or the second arm, Δh is a difference in height between the second sensor and the first sensor, ρ is a density of the liquid, g is the gravitational constant, Pₑₓₜ is a pressure of the external atmosphere or the external pressure source, t₁ is a time at which the liquid rises or lowers to the first sensor, and t₂ is a time at which the liquid rises or lowers to the second sensor.

In at least some embodiments of t the apparatus, the redox flow battery system, the methods, or the computer readable medium, the method or actions further include determining or estimating a gas generation rate, ν, using the following equation:

$$v = {Q}_{gas} * 22.4 \frac{mol}{L} .$$

In at least some embodiments of the apparatus, the redox flow battery system, the methods, or the computer readable medium, the method or actions further include, after the determining, opening the second valve. In at least some embodiments of the apparatus, the redox flow battery system, the methods, or the computer readable medium, the method or actions further include, after the determining, closing the first valve. In at least some embodiments of the apparatus, the redox flow battery system, the methods, or the computer readable medium, the method or actions further include repeating the opening, the determining, and the closing a plurality of times.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of one embodiment of a redox flow battery system, according to the invention;

FIG. 2A is a schematic diagram of one embodiment of an electrolyte tank of a redox flow battery system with a pressure release valve, according to the invention;

FIG. 2B is a schematic diagram of one embodiment of an electrolyte tank of a redox flow battery system with a liquid-containing U-tube arrangement, according to the invention;

FIG. 3A is a schematic diagram of one embodiment of a U-tube arrangement, according to the invention;

FIG. 3B is a schematic diagram of the U-tube arrangement of FIG. 3A, where gas pressure has increased in one arm, according to the invention;

FIG. 4 is a flowchart of one embodiment of a method for monitoring, observing, or measuring gas generation or gas flow, according to the invention;

FIG. 5A is a schematic diagram of one embodiment of a system that includes a redox flow battery system in conjunction with a balancing arrangement, according to the invention; and

FIG. 5B is a schematic diagram of one embodiment of the balancing arrangement of the system of FIG. 5A, according to the invention.

### DETAILED DESCRIPTION

The present invention is directed to the area of redox flow battery systems and methods of making and using redox flow battery systems. The present invention is also directed systems and methods for gas flow rate measurement, observation, or monitoring for redox flow battery systems or other closed systems and methods of making and using.

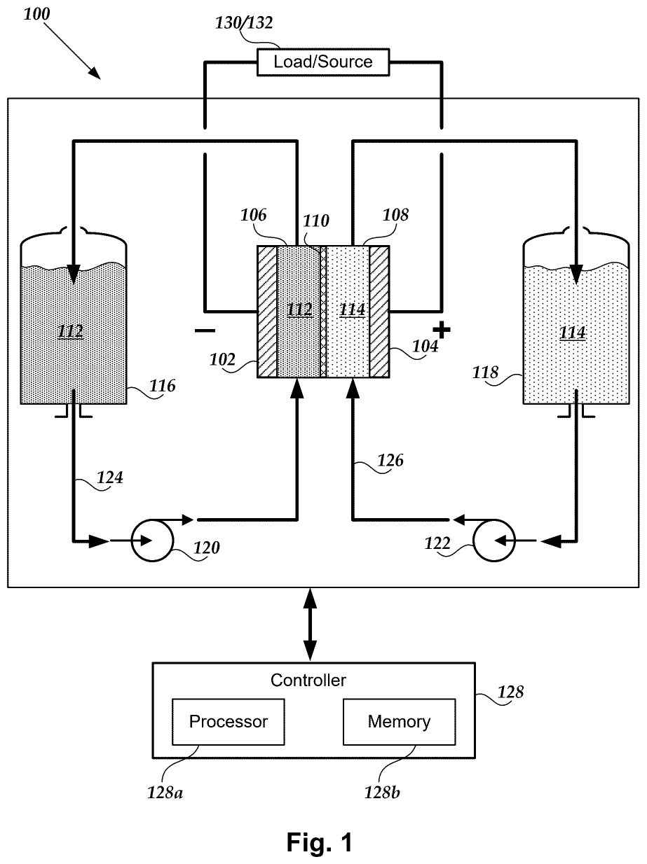

Redox flow battery systems are a promising technology for the storage of energy generated by renewable energy sources, such as solar, wind, and hydroelectric sources, as well as non-renewable and other energy sources. FIG. 1 illustrates one embodiment of a redox flow battery system 100. It will be recognized that other redox flow battery systems 100 may include more or fewer elements and the elements may be arranged differently than shown in the illustrated embodiments. It will also be recognized that the description below of components, methods, systems, and the like can be adapted to other redox flow battery systems different from the illustrated embodiments.

The redox flow battery system 100 of FIG. 1 includes two electrodes 102, 104 and associated half-cells 106, 108 that are separated by a separator 110. The electrodes 102, 104 can be in contact with, or separated from, the separator. Electrolyte solutions flow through the half-cells 106, 108 and are referred to as the anolyte 112 and the catholyte 114. The redox flow battery system 100 further includes an anolyte tank 116, a catholyte tank 118, an anolyte pump 120, a catholyte pump 122, an anolyte distribution arrangement 124, and a catholyte distribution arrangement 126.

The anolyte 112 is stored in the anolyte tank 116 and flows around the anolyte distribution arrangement 124, at least in part through action of the anolyte pump 120, to the half-cell 106. The catholyte 114 is stored in the catholyte tank 118 and flows around the catholyte distribution arrangement 126, at least in part through action of the catholyte pump 122, to the half-cell 108. It will be recognized that, although the illustrated embodiment of FIG. 1 includes a single one of each of the components, other embodiments can include more than one of any one or more of the illustrated components. For example, other embodiments can include multiple electrodes 102, multiple electrodes 104, multiple anolyte tanks 116, multiple catholyte tanks 118, multiple half-cells 112, or multiple half-cells 114, or any combination thereof.

Examples of redox flow battery systems and methods of using and making such systems are disclosed in U.S. Pat. Nos. 10,777,836; 10,826,102; 11,189,854; 11,201,345; 11,233,263; 11,626,607; 11,626,608; 11,764,385; 11,990,659; and 11,955,677 and U.S. Patent Application Publications Nos. 2022/0158212 and 2023/0282861, all of which are incorporated herein by reference in their entireties. The redox flow battery systems and methods in these cited references can be modified to include any of the components, methods, techniques or the like described herein or used in the methods described herein. In addition, the redox flow battery systems and methods disclosed herein can be modified to include any of the components, methods, techniques or the like described in these cited references or used in the methods described in these cited references.

The redox flow battery system 100 can be attached to a load/source 130/132, as illustrated in FIG. 1. In a charge mode, the redox flow battery system 100 can be charged or recharged by attaching the flow battery to a source 132. The source 132 can be any power source including, but not limited to, fossil fuel power sources, nuclear power sources, other batteries or cells, or renewable power sources, such as wind, solar, or hydroelectric power sources. In a discharge mode, the redox flow battery system 100 can provide energy to a load 130.

In the charge mode, the redox flow battery system 100 converts electrical energy from the source 132 into chemical potential energy. In the discharge mode, the redox flow battery system 100 converts the chemical potential energy back into electrical energy that is provided to the load 130.

The redox flow battery system 100 can also be coupled to a controller 128 that can control operation of the redox flow battery system. For example, the controller 128 may connect or disconnect the redox flow battery system 100 from the load 130 or source 132. The controller 128 may control operation of the anolyte pump 120 and catholyte pump 122. The controller 128 may control operation of valves associated with the anolyte tank 116, catholyte tank 118, anolyte distribution system 124, catholyte distribution system 126, or half-cells 106, 108. The controller 128 may be used to control general operation of the redox flow battery system 100 include switching between charge mode, discharge mode, and, optionally, a maintenance mode (or any other suitable modes of system operation.) In at least some embodiments, the controller or the redox flow battery system may control the temperature within the half-cells 106, 108 or elsewhere in the system. In at least some embodiments, the temperature of the half-cells (or the system in general or portions of the system) is controlled to be no more than 65, 60, 55, or 50 degrees Celsius during operation.

Any suitable controller 128 can be used including, but not limited to, one or more computers, laptop computers, servers, any other computing devices, or the like or any combination thereof and may include components such as one or more processors, one or more memories, one or more input devices, one or more display devices, and the like. The controller 128 may be coupled to the redox flow battery system through any wired or wireless connection or any combination thereof. The controller 128 (or at least a portion of the controller) may be located local to the redox flow battery system 100 or located, partially or fully, non-locally with respect to the redox flow battery system.

In at least some embodiments, the controller 128 includes a processor 128a and memory 128b for storage of instructions. The processor 128a executes the instructions for operation of the redox flow battery system. Any suitable processor 128a and memory 128b can be used.

The electrodes 102, 104 can be made of any suitable material including, but not limited to, graphite or other carbon materials (including solid, felt, paper, or cloth electrodes made of graphite or carbon), gold, titanium, lead, or the like. Other examples of electrodes 102, 104 are described in the references cited herein. The two electrodes 102, 104 can be made of the same or different materials. In at least some embodiments, the redox flow battery system 100 does not include any homogenous or metallic catalysts for the redox reaction in the anolyte or catholyte or both. This may limit the type of material that may be used for the electrodes.

The separator 110 separates the two half-cells 106, 108. In at least some embodiments, the separator 110 allows the transport of selected ions (for example, H⁺, Cl⁻, or iron or chromium ions or any combination thereof) during the charging or discharging of the redox flow battery system 100. In some embodiments, the separator 110 is a microporous membrane. Any suitable separator 110 can be used and examples of suitable separator include, but are not limited to, ion transfer membranes, anionic transfer membranes, cationic transfer membranes, microporous separators, or the like or any combination thereof.

The anolyte and the catholyte are electrolytes and can be the same electrolyte or can be different electrolytes. In at least some embodiments, during energy flow into or out of the redox flow battery system 100, the electrolyte in one of the half-cells 106, 108 is oxidized and loses electrons and the electrolyte in the other one of the half-cells is reduced and gains electrons.

One example of a redox flow battery system is an iron-chromium (Fe—Cr) redox flow battery system utilizing Fe³⁺/Fe²⁺ and Cr³⁺/Cr²⁺ redox chemistry. This Fe—Cr redox flow battery system will be used as an example herein; however, it will be understood that any other redox flow battery system can be used. In at least some embodiments, the electrolytes (i.e., the catholyte or anolyte) of a Fe—Cr redox flow battery system include, respectively, an iron-containing compound or a chromium-containing compound dissolved in a solvent. In some embodiments, the anolyte and catholyte contain both the iron-containing compound and the chromium-containing compound.

In at least some embodiments of an Fe—Cr redox flow battery system, the following primary electrolytic reactions occur at the electrodes:

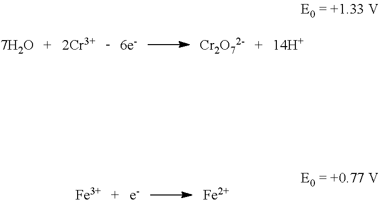

In at least some embodiments, the chromium-containing compound can be, for example, chromium chloride, chromium sulfate, chromium bromide, a chromium complex with at least one nitrogen-containing ligand (such as, for example, ammonia (NH₃), ammonium (NH₄⁺), urea (CO(NH₂)₂), thiocyanate (SCN⁻), or thiourea (CS(NH₂)₂), or any combination thereof), or the like or any combination thereof. The iron-containing compound can be, for example, iron chloride; iron sulfate; iron bromide; an iron complex including at least one of ammonia (NH₃), ammonium (NH₄⁺), urea (CO(NH₂)₂), thiocyanate (SCN⁻), or thiourea (CS(NH₂)₂) as a ligand; or the like or any combination thereof. Other examples of chromium-containing compounds and iron-containing compounds can be found in the references cited herein.

The solvent can be water; an aqueous acid, such as, hydrochloric acid, hydrobromic acid, sulfuric acid, or the like; or an aqueous solution including a soluble salt of a weak acid or base, such as ammonium chloride. In at least some embodiments, the water content of the anolyte or catholyte (or both) is at least 40, 45, or 50 wt. %. In at least some embodiments, both the catholyte and the anolyte of an Fe—Cr redox flow battery system includes iron chloride and chromium chloride dissolved in hydrochloric acid. In at least some embodiments, the catholyte of an Fe—Cr redox flow battery system includes iron chloride dissolved in hydrochloric acid and the anolyte includes chromium chloride dissolved in hydrochloric acid.

One challenge of Fe—Cr redox flow batteries is the generation or evolution of hydrogen (H₂) at the negative electrode as a result of side reactions. In at least some instances, increasing the utilization of the chromium in the redox flow battery can increase the production of hydrogen. In at least some instances, it is found that higher H⁺ concentration in the anolyte promotes hydrogen generation. In at least some instances, the metal impurities can increase hydrogen generation on the negative electrode surface.

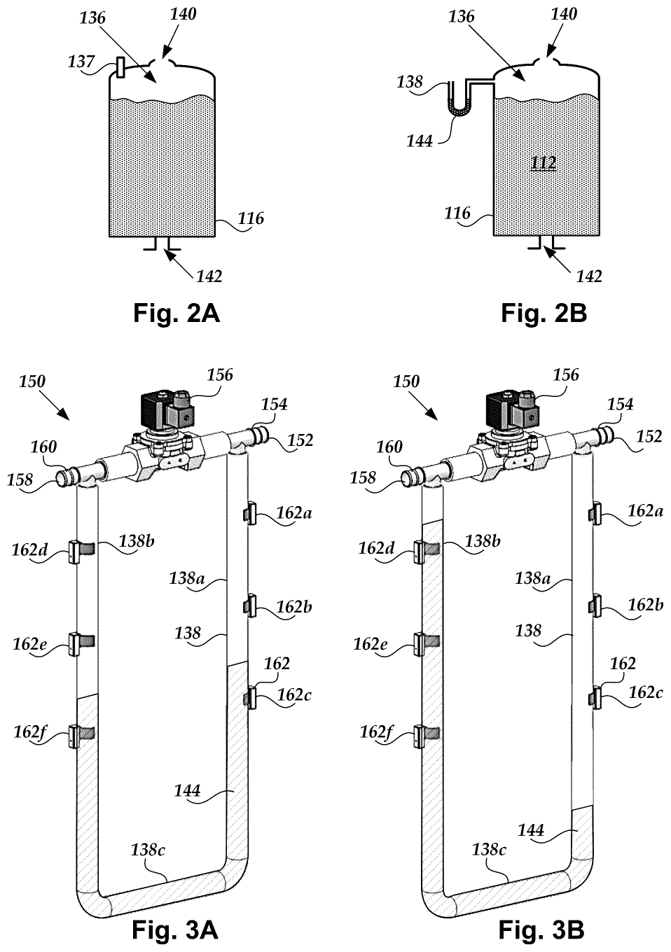

In at least some embodiments, the redox flow battery system 100 includes a pressure release system to manage pressure in the catholyte or anolyte headspace. Each of the anolyte and catholyte tanks 116, 118 includes at least one inlet 140 and at least one outlet 142 and has a headspace 136 that contains gas rather than liquid. For example, a pressure relief valve 137 (FIG. 2A) or a U-tube 138 containing liquid 144 (FIG. 2B) may be coupled to the headspace 136 of the anolyte tank 116 to manage the pressure. Similarly or alternatively, a pressure relief valve or a liquid-containing U-tube arrangement may be coupled to the anolyte headspace. In at least some embodiments, gas in the headspace 136 may exchange with an environmental atmosphere via a bi-directional gas pressure control system such as the U-tube arrangement. In at least some embodiments, a U-tube arrangement may also be used as a gas leak monitor. In at least some embodiments, the liquid in a U-tube arrangement may contain an acid level indicator that can be used to estimate the amount of acid-containing gas released into the environment by the redox flow battery system.

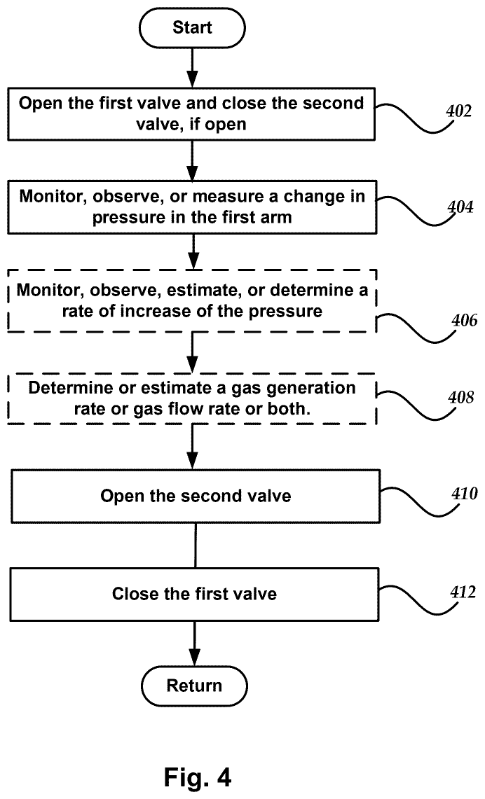

In at least some embodiments, it is desirable to monitor, observe, or measure gas generation or gas flow of a redox flow battery system. The gas generation or gas flow can arise from side reactions or desired electrolytic reactions. One embodiment of a U-tube arrangement 150 is illustrated in FIGS. 3A and 3B and can be used to observe, monitor, or measure gas generation or gas flow in the anolyte or catholyte portion of the redox flow battery system or for managing pressure in the anolyte or catholyte headspace 136. For example, the U-tube arrangement can be used to observe, monitor, or measure gas generation of hydrogen, oxygen, nitrogen, carbon dioxide, chlorine, hydrogen sulfide, or the like or any combination thereof.

The U-tube arrangement 150 of FIGS. 3A and 3B includes a U-tube 138 with two arms 138a, 138b and a bridge 138c between the two arms, liquid 144 disposed in the U-tube, an attachment conduit 152 with a first valve 154, a second valve 156, an external conduit 158 optionally with an optional third valve 160, and multiple liquid level sensors 162 (such as, for example, liquid level sensors 162a, 162b, 162c, 162d, 162e, 162f) disposed along the U-tube. The U-tube 138, the attachment conduit 152, and the external conduit 158 can be made of any suitable material including, but not limited to, metals, alloys, plastics, or the like. Any suitable liquid can be used including, but not limited to, water, saline, ethanol glycol, hydrocarbon mineral oils, or the like.

The first valve 154, the second valve 156, and the optional third valve 160 can be any suitable valves and may be the same or different. In at least some embodiments, one or more of the first valve 154, the second valve 156, or the optional third valve 160 is a valve selected for resistance to degradation by the anolyte, catholyte, generated gas, or any combination thereof. In at least some embodiments, one or more of the first valve 154, the second valve 156, or the optional third valve 160 is processor-controlled or processor-controllable. For example, the controller 128 (FIG. 1), or a separate controller, can operate the first valve 154, the second valve 156, or the optional third valve 160.

The liquid level sensors 162 can be disposed on, or adjacent to, the external surface of the U-tube 138 or disposed within the U-tube or any combination thereof. Any suitable liquid level sensors can be used. Examples of suitable liquid level sensors include, but are not limited to, capacitance level sensors, conductively level sensors, ultrasound level sensors, radar level sensors, vibrating level sensors, optical level sensors, float level sensors, or the like or any combination thereof. Any suitable number of liquid level sensors 162 can be included in the U-tube arrangement 150 including, but not limited to, two, three, four, five, six, eight, ten, twelve, or more liquid level sensors. In at least some embodiments, one of the arms 138a, 138b, or individually each of the arms, includes two, three, four, five, six, eight, ten, twelve, or more liquid level sensors 162. In at least some embodiments, the liquid level sensors are coupled to a processor for control and for reporting the liquid level. For example, the controller 128 (FIG. 1), or a separate controller, can operate the liquid level sensors 162 and receive signals from the liquid level sensors regarding the liquid level in the U-tube 138.

One arm 138a of the U-tube 138 is in fluid communication with the attachment conduit 152 and the other arm 138b is in fluid communication with the external conduit 158. The liquid level sensors 162 can be disposed along only one of the arms 138a, 138b or along both arms. The liquid level sensors 162 on either arm 138a, 138b can have the same distance between adjacent liquid level sensors or different distances between adjacent liquid level sensors.

The attachment conduit 152 is attached to, and in fluid communication with, the headspace 136 of the anolyte tank 116 or the catholyte tank 118 or any other portion of the redox flow battery system 100 that has a headspace. When the first valve 154 is opened, gas from the headspace 136 can flow into the attachment conduit 152 and then into the first arm 138a of the U-tube 138. The second arm 138b is open to the external atmosphere or another pressure source through external conduit 158 when the optional third valve is not present or the optional third valve 160, when present, is open. The second valve 156, when opened, exposes the first arm 138a to the external atmosphere or other pressure source. In at least some embodiments, with the second valve 156 open and the third value 160 either open or absent, the level of liquid 144 in both arms 138a, 138b is equal or approximately equal (e.g., no more than 10% or 5% difference in height of liquid), as illustrated in FIG. 3A.

It will be understood that the U-tube arrangement 150 can be used to monitor, observe, or measure gas generation or gas flow in any closed system. The anolyte tank 116, the catholyte 118, or the redox flow battery system 100, in general, used herein as examples of the closed system. The methods, U-tube arrangements, and other features of the U-tube arrangements can be used with any suitable closed system. A closed system is any system that can be closed to release of gas generated within the system and does not preclude systems that include valves or other mechanisms for releasing gas generated within the system as long as there is a mechanism, method, or other arrangement for closing the system.

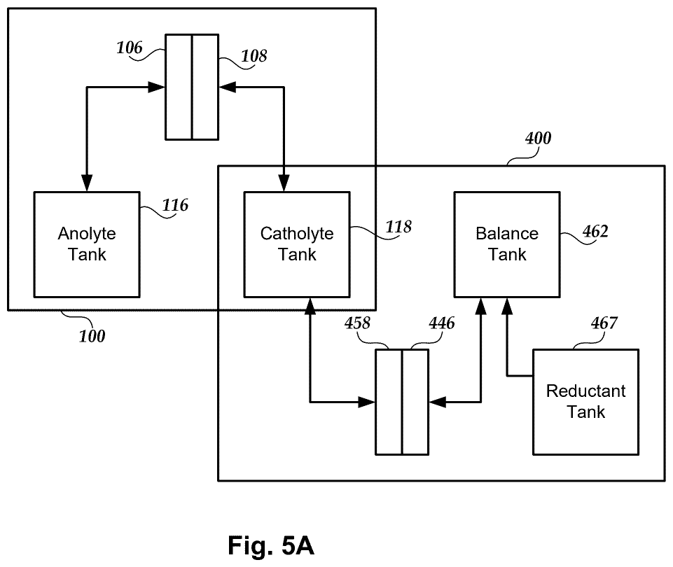

FIG. 4 illustrates one method for monitoring, observing, or measuring gas generation or gas flow. In step 402, the first valve 154 is opened (with the second valve closed) and the levels of the liquid 144 along the two arms 138a, 138b is adjusted, as illustrated in FIG. 3B, based on the relative pressure between the headspace 136 of the catholyte or anolyte tank 116, 118 and the external atmosphere or other external pressure source. (It will be understood that the headspace 136 can represent a headspace or gas-filled space in any other closed system.) As gas is generated by the redox flow battery system 100, the pressure in the headspace 136 increases.

In step 404, the change in pressure in the first arm is monitored, observed, or measured. For example, a change in level of the liquid 144 in the U-tube 138 is determined using at least one of the liquid level sensors. The position of the liquid 144 along either arm 138a, 138b of the U-tube 138 can indicate a pressure in the first arm 138a, which is in fluid communication with the headspace 136 of the catholyte or anolyte tank 116, 118, relative to the external atmosphere or other external pressure source. In at least some embodiments, in optional step 406, a rate of increase of the pressure can be observed, monitored, estimated, or determined by the difference in time as the fluid level in one of the arms 138a, 138b moves past two liquid level sensors 162 (e.g., liquid level sensors 162e, 162d or liquid level sensors 162b, 162c).

In at least some embodiments, in optional step 408, a gas generation rate or gas flow rate (or both) can be estimated or determined. For example, in at least some embodiments, the gas flow rate Q_{gas}, in L/min, can be estimated or determined as follows:

$${Q}_{gas} = ( A * Δ h ) * ( 1 + \frac{2 * Δ h * ρ * g}{{P}_{ext}} ) / ( {t}_{2} - {t}_{1} )$$

where A is the cross-sectional area of an arm (e.g., arm 358b) of the U-tube, Δh is a difference in height between a first liquid level sensor and a second liquid level sensor (for example, liquid level sensor 162e and liquid level sensor 162d) along one of the arms 138a, 138b, ρ is a density of the liquid, g is the gravitational constant, Pₑₓₜ is a pressure of the external atmosphere or the external pressure source, and tᵢ is the time that the liquid 144 is detected by the it liquid level sensor (for example, liquid level sensor 162e or liquid level sensor 162d). In at least some embodiments, Δh is equal to (h₂−h₁), where hᵢ is the height of the i^{th} liquid level sensor along the arm (for example, liquid level sensor 162e or liquid level sensor 162d).

The gas generation rate, ν, can be estimated or determined as follows:

$$v = {Q}_{gas} * 22.4 \frac{mol}{L} .$$

In at least some embodiments, the gas generation reaction is a side reaction and the gas generation rate, ν, is the side reaction rate (or proportional to the side reaction rate). In at least some embodiments, the gas generation reaction is a desired reaction and the gas generation rate, ν, is the desired reaction rate (or proportional to the desired reaction rate).

In at least some embodiments, multiple measurements, observations, estimations, or determinations can be made. In at least some embodiments, after a measurement (or observation or monitoring) period, which may have the same duration as previous or subsequent measurement (or observation or monitoring) periods or different duration, in step 410, the second valve 156 is opened to relieve the pressure from the generated gas. In at least some embodiments, in optional step 412, the first valve 154 is closed. In other embodiments, the first valve 154 is not closed. In at least some embodiments, step 412 can occur prior to, or simultaneously with, step 410.

In at least some embodiments, another measurement(s), observation(s), or determination(s) can be made by closing the second valve 156 and opening the first valve 154, if closed. Steps 402 to 412 can be repeated multiple times. In at least some embodiments, steps 402 to 412 are performed continuously. In at least some embodiments, steps 402 to 412 are performed at regular periods or irregular periods. In at least some embodiments, steps 402 to 412 are initiated manually. In at least some embodiments, a redox flow battery system can be capable of continuous performance, periodic performance, or manual initiation or any combination thereof. In at least some embodiments, a processor, such as controller 128 (FIG. 1), can initiate steps 402 to 412. In at least some embodiments, a processor, such as controller 128 (FIG. 1), can perform one or more (or all) of steps 402 to 412.

As an example of gas generation, in at least some embodiments, the presence of ammonia or urea in the electrolytes (for example, as ligands of the chromium complex) can facilitate rebalancing of the system and restoration of the storage capacity. In at least some embodiments, the following electrolytic reactions occur at the electrodes:

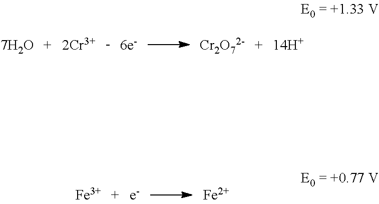

The chromate ions can react with urea or ammonia to regenerate Cr³⁺ to rebalance the system:

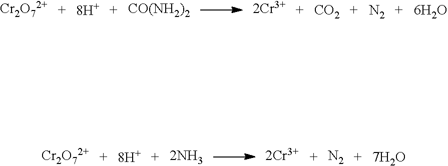

In at least some embodiments, the resulting nitrogen or carbon dioxide can be released to prevent pressurization of the redox flow battery system.

Alternatively or additionally, in at least some embodiments, to rebalance the redox flow battery system the redox flow battery system includes a balance arrangement, in conjunction with either the anolyte or catholyte, to rebalance the system and restore storage capacity. In at least some embodiments, the balance arrangement utilizes a vanadium source (to produce oxovanadium (VO²⁺) and dioxovanadium (VO₂⁺) ionic species) and a reductant, such as an oxidizable hydrocarbon compound, to rebalance the system and restore storage capacity. The following embodiments illustrate the addition of a balance arrangement to a Fe—Cr redox flow battery system. It will be understood that such balance arrangements can be used with other redox flow battery systems, or other chemical and/or electrochemical systems.

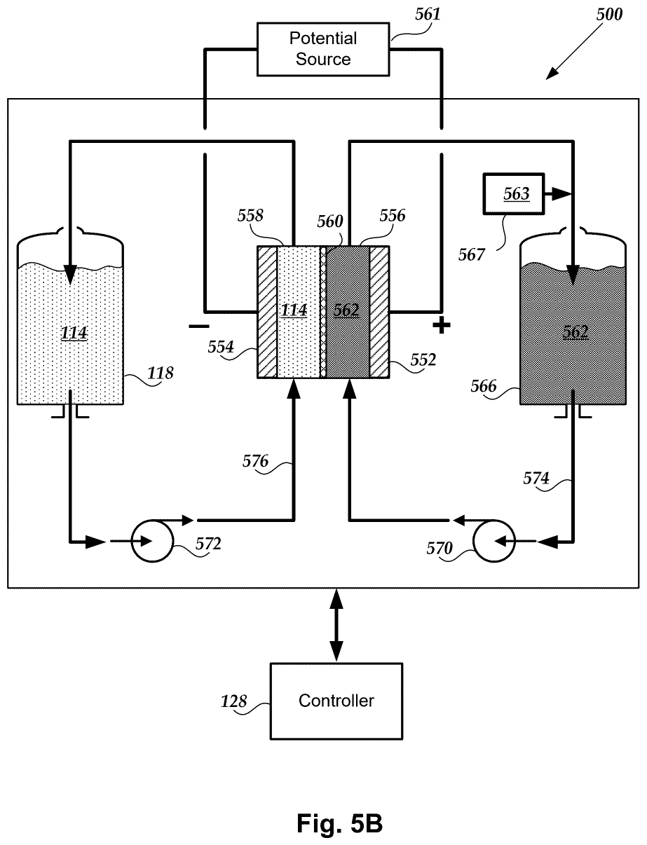

FIG. 5A illustrates one embodiment of portions of the redox flow battery system 100 and a balance arrangement 500. FIG. 5B illustrates one embodiment of the balance arrangement 500. In this embodiment, the catholyte 114 is used in conjunction with a balancing electrolyte 562 (for example, an electrolyte containing VO²⁺/VO₂⁺) and a reductant 563 to rebalance the redox flow battery system 100. The balance arrangement 500 includes the catholyte tank 118; balance electrodes 552, 554; balance half-cells 556, 558; balance separator 560; catholyte balance pump 572; catholyte balance distribution system 576; balance tank 566; optional reductant tank 567; balance electrolyte pump 570; balance electrolyte distribution arrangement 574; and potential source 561. In at least some embodiments, the reductant can be urea or ammonia which may be present as ligands of a chromium or iron complex or can be otherwise provided as a reductant.

The following reaction equations illustrate one example of the rebalancing of the system using the iron-based catholyte 114, a balancing electrolyte 562 containing oxovanadium ions, and a reductant 563 containing urea or ammonia.

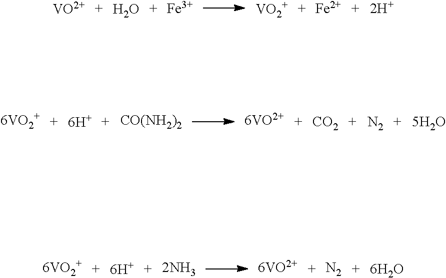

In at least some embodiments, the resulting nitrogen or carbon dioxide can be released to prevent pressurization of the redox flow battery system.

The following reaction equations illustrate another example of the rebalancing of the system using the iron-based catholyte 114, a balancing electrolyte 562 containing oxovanadium ions, and a reductant 563 containing fructose, along with the application of an external potential from the potential source 561 of at least 0.23 V:

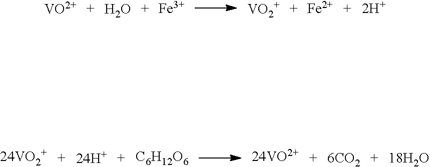

In at least some embodiments, the oxidation of the reductant 563 can be performed in the balance tank 566 instead of the half-cell 556 and may not require the application of an external potential, as long as VO₂⁺ ions are available. Suitable reducing agents include sugars (for example, fructose, glucose, sucrose, or the like or any combination thereof), carboxylic acids (for example, formic acid, acetic acid, propionic acid, oxalic acid, or the like or any combination thereof), aldehydes (for example, formaldehyde, acetaldehyde, or the like or any combination thereof), alcohols (for example, methanol, ethanol, propanol, or the like or any combination thereof), ammonia, urea, thiourea, ammonium ions, other hydrocarbons, or hydrogen gas. In at least some embodiments, the reductant is soluble or at least partially soluble in water.

Additional non-limiting examples of balance arrangements and redox flow battery systems with balance arrangements can be found in the references cited above.

In a balance arrangement, the U-tube arrangement 150 of FIGS. 3A and 3B can be to monitor, observe, or measure gas generation or gas flow associated with the balance tank 562 or the reductant tank 567 or any other tank of a redox flow battery system. For example, the U-tube arrangement 150 can be used to monitor, observe, or measure the generation of carbon dioxide or nitrogen in the headspace of the balance tank 562.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of processor and any suitable type of device that includes a processor.

It will be understood that each block of the flowchart illustrations, and combinations of blocks in the flowchart illustrations and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium (such as memory 128b of FIG. 1) including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium (which may be local or nonlocal to the computer) which can be used to store the desired information and which can be accessed by a processor.

The above specification provides a description of the manufacture and use of the invention. Since many embodiments of the invention can be made without departing from the spirit and scope of the invention, the invention also resides in the claims hereinafter appended.

What is claimed as new and desired to be protected is:

1. A redox flow battery system, comprising:
an anolyte;
a catholyte;
a first electrode;
a second electrode;
a first half-cell in which the first electrode is in contact with the anolyte;
a second half-cell in which the second electrode is in contact with the catholyte;
an anolyte tank in fluid communication with the first half-cell;
a catholyte tank in fluid communication with the second half-cell; and
a U-tube arrangement coupled to either the anolyte tank or the catholyte tank to monitor, observe, or measure gas in a headspace of the anolyte tank or the catholyte tank, the U-tube arrangement comprising
a U-tube comprising a first arm, a second arm, and a bridge connecting the first arm to the second arm;
a liquid disposed in the U-tube;
an attachment conduit configured for coupling to the anolyte tank or the catholyte tank and in fluid communication with the first arm of the U-tube and either the anolyte tank or the catholyte tank;
a first valve for controlling fluid flow between the first arm of the U-tube and either the anolyte tank or the catholyte tank;
an external conduit in fluid communication with the second arm of the U-tube and either an external atmosphere or external pressure source; and
a plurality of liquid level sensors disposed along at least one of the first arm or the second arm.

2. The redox flow battery system of claim 1, wherein the U-tube arrangement further comprises a second valve for controlling fluid flow between the first arm of the U-tube and the external atmosphere.

3. The redox flow battery system of claim 1, wherein the U-tube arrangement further comprises a third valve for controlling fluid flow from the second arm of the U-tube and the external atmosphere or external pressure source.

4. The redox flow battery system of claim 1, wherein the plurality of liquid level sensors comprises at least three liquid level sensors disposed along the first arm or the second arm.

5. The redox flow battery system of claim 1, further comprising
a memory having instructions stored thereon; and
a processor coupled to the memory, the first valve, and the liquid level sensors and configured to execute the instructions to perform actions, the actions comprising
opening the first valve to provide fluid communication between either the anolyte tank or catholyte tank and the U-tube; and
determining a change in level of the liquid along at least one of the first arm or the second arm of the U-tube using two of the liquid level sensors.

6. The redox flow battery system of claim 1, wherein the liquid level sensors comprise a first sensor and a second sensor disposed along a one of the first arm or the second arm, wherein determining the change in the level comprises, for each of the first sensor and the second sensor, determining a time that the liquid rises or lowers to that sensor.

7. The redox flow battery system of claim 6, wherein the actions further comprise determining or estimating a gas flow rate, Q_{gas} using the following equation:
$${Q}_{gas} = ( A * Δ h ) * ( 1 + \frac{2 * Δ h * ρ * g}{{P}_{ext}} ) / ( {t}_{2} - {t}_{1} )$$
wherein A corresponds to a cross-sectional area of the one of the first arm or the second arm, Δh is a difference in height between the second sensor and the first sensor, ρ is a density of the liquid, g is the gravitational constant, Pₑₓₜ is a pressure of the external atmosphere or the external pressure source, t₁ is a time at which the liquid rises or lowers to the first sensor, and t₂ is a time at which the liquid rises or lowers to the second sensor.

8. The redox flow battery system of claim 7, wherein the actions further comprise determining or estimating a gas generation rate, ν, using the following equation:
$$v = {Q}_{gas} * 22.4 \frac{mol}{L} .$$

9. A method of measuring, observing, or monitoring gas generation in the redox flow battery system of claim 1, the method comprising:
opening the first valve to provide fluid communication between either the anolyte tank or catholyte tank and the U-tube; and
determining a change in level of the liquid along at least one of the first arm or the second arm of the U-tube using two of the liquid level sensors.

10. The method of claim 9, further comprising, after the determining, opening the second valve.

11. The method of claim 9, further comprising, after the determining, closing the first valve.

12. The method of claim 11, further comprising repeating the opening, the determining, and the closing a plurality of times.

13. The method of claim 9, wherein the liquid level sensors comprise a first sensor and a second sensor disposed along a one of the first arm or the second arm, wherein the determining comprises, for each of the first sensor and the second sensor, determining a time that the liquid rises or lowers to that sensor.

14. The method of claim 13, further comprising determining or estimating a gas flow rate, Q_{gas} using the following equation:
$${Q}_{gas} = ( A * Δ h ) * ( 1 + \frac{2 * Δ h * ρ * g}{{P}_{ext}} ) / ( {t}_{2} - {t}_{1} )$$
wherein A corresponds to a cross-sectional area of the one of the first arm or the second arm, Δh is a difference in height between the second sensor and the first sensor, ρ is a density of the liquid, g is the gravitational constant, Pₑₓₜ is a pressure of the external atmosphere or the external pressure source, t₁ is a time at which the liquid rises or lowers to the first sensor, and t₂ is a time at which the liquid rises or lowers to the second sensor.

15. The method of claim 14, further comprising determining or estimating a gas generation rate, ν, using the following equation:
$$v = {Q}_{gas} * 22.4 \frac{mol}{L} .$$

16. A computer readable medium having instructions stored thereon that, when executed by a processor, perform actions, the actions comprising:
opening the first valve of the redox flow battery system of claim 1 to provide fluid communication between either the anolyte tank or catholyte tank and the U-tube; and
determining a change in level of the liquid along at least one of the first arm or the second arm of the U-tube using two of the liquid level sensors.

17. The computer readable medium of claim 16, wherein the actions further comprise, after the determining, opening the second valve.

18. The computer readable medium of claim 16, wherein the actions further comprise, after the determining, closing the first valve.

19. An apparatus for monitoring, observing, or measuring gas generation in a closed system, the apparatus comprising:
a U-tube arrangement comprising
a U-tube comprising a first arm, a second arm, and a bridge connecting the first arm to the second arm,
a liquid disposed in the U-tube,
an attachment conduit configured for coupling to the closed system and in fluid communication with the first arm of the U-tube and the closed system,
a first valve for controlling fluid flow between the first arm of the U-tube and the closed system,
an external conduit in fluid communication with the second arm of the U-tube and either an external atmosphere or external pressure source, and
a plurality of liquid level sensors disposed along at least one of the first arm or the second arm;
a memory having instructions stored thereon; and
a processor configured to execute the instructions to perform actions, the actions comprising
opening the first valve to provide fluid communication between the closed system and the U-tube;
determining a change in level of the liquid along at least one of the first arm or the second arm of the U-tube using two of the liquid level sensors; and
monitoring, observing, or determining a gas flow rate based on the change in the level of the liquid between the two of the liquid level sensors and a time to produce the change in the level of the liquid between the two liquid level sensors.

20. A method of measuring, observing, or monitoring gas generation in the apparatus of claim 19, the method comprising:
opening the first valve to provide fluid communication between closed system and the U-tube; and
determining a change in level of the liquid along at least one of the first arm or the second arm of the U-tube using the two of the liquid level sensors.
